(19) United States
(12) Patent Application Publication
(10) Pub. No.: US 2006/0258317 A1
(43) Pub. Date: Nov. 16, 2006

(54) DC offset calibration system

(75) Inventor: Takeaki Watanabe, Kyoto (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Osaka (JP)

(21) Appl. No.: 11/415,835

(22) Filed: May 2, 2006

(30) Foreign Application Priority Data
May 12, 2005 (JP) JP2005-139934

(51) Int. Cl. H04B 1/00; H04B 1/10; H04B 15/00

(52) U.S. Cl. 455/296; 455/63.1

(57) ABSTRACT

A DC offset calibration system includes: a mixer 1 for direct conversion; a detector 2 that detects a level of an RF input signal; a controller 4 that generates a compensation signal for compensating for a dynamic DC offset based on an output from the detector; a comparator 9 that discriminates a polarity of the DC offset; a static DC offset compensator 13 that generates a static DC offset compensation signal for making a DC offset when there is no input of the RF input signal zero; and an adjustment signal generator 16 that generates an adjustment signal for determining the magnitude of the compensation signal generated by the controller. When determining the magnitude of the adjustment signal, calibration that determines a magnitude of the static DC offset compensation signal when there is no input of the RF input signal based on an output from the comparator and calibration that determines the magnitude of the adjustment signal when an interfering wave is input based on the output from the comparator are repeated alternately a plurality of times. With this configuration, it becomes possible to reduce an adjustment error of a dynamic DC offset due to manufacturing variations, when compensating for the DC offset generated in an output from the mixer by the interfering wave input.

### BACKGROUND OF THE INVENTION

1. Field of the Invention

The present invention relates to a system for compensating for a DC offset that occurs in a radio receiver employing a direct conversion system when an interfering wave is input thereto.

2. Description of Related Art

In recent years, technology that uses a direct conversion system has been proposed as a system suitable for miniaturization and price reduction of radio receivers. In this system, an RF input signal is converted directly to a low-frequency baseband signal, and so in comparison to a conventional system that requires an intermediate frequency, it has the advantage that an intermediate frequency filter is not necessary.

Frequency conversion is performed by mixing an RF input signal with a local signal having the same frequency as the RF input signal using a mixer. However, in a direct conversion system, when second order nonlinear distortion is present in the mixer, a DC offset occurs in the output baseband signal in accordance with the level of the input signal. This DC offset will be described in detail with reference to FIGS. 5 and 6.

FIG. 5 shows the spectrum of an input RF signal, including a weak-level desired wave 30 whose center frequency is the same as a local signal frequency f_{LO} and a high-level interfering wave 31 present at a frequency f_{INT} that is different from f_{LO}. When an RF input signal including such a high-level interfering wave is input to a mixer, an output signal appearing in the mixer output will have a spectrum as shown in FIG. 6. Frequency components 32 and 33 respectively correspond to the mixer outputs after frequency conversion of the desired wave 30 and the interfering wave 31 of the RF input. When second order nonlinear distortion is present in the mixer, a DC offset 34 is generated by the high-level interfering wave 31. In this way, in a direct conversion system, there is a problem in that the receiver sensitivity decreases because of the DC offset 34 generated in the frequency range of the desired wave 32 of the mixer output.

The value of this DC offset varies depending on the interfering wave level. In order to distinguish this DC offset from a DC offset that is present in an output when there is no input of the RF input signal and is independent of the interfering wave level, the former is referred to as a “dynamic DC offset” and the latter is referred to as a “static DC offset”. If the differential balance is perfectly symmetrical in a differential circuit constituting the mixer, the second order nonlinear distortion is not present. However, the elements constituting the differential circuit cannot be made completely symmetrical due to manufacturing variations. Therefore, eliminating the second order nonlinear distortion practically is impossible.

Thus, technology for compensating for a dynamic DC offset caused by the second order nonlinear distortion has been proposed. For example, U.S. Pat. No. 6,535,725 discloses a method for compensating for a dynamic DC offset that occurs in the mixer output by detecting an interfering wave included in an RF input signal. The method disclosed in U.S. Pat. No. 6,535,725 will be described below with reference to FIG. 7. FIG. 7 schematically shows a circuit constituting a DC offset calibration system, which includes a mixer 1 and a dynamic DC offset compensator 40 connected thereto.

The mixer 1 includes an RF input cell 41 and a switching cell 42. The RF input cell 41 includes bipolar transistors Q5 and Q6 and resistors R. The switching cell 42 includes bipolar transistors Q1, Q2, Q3, and Q4. An RF signal input from RF input terminals 43 and 44 is amplified in the RF input cell 41. In the switching cell 42, the amplified RF signal is mixed with a local signal that is input from local input terminals 45 and 46, and thus is converted into a baseband signal whose center frequency is DC. The baseband signal is output from output terminals 47 and 48.

If all the bipolar transistors Q1, Q2, Q3, and Q4 included in the switching cell 42 have exactly the same properties, the balance of a differential circuit is perfectly symmetrical. However, because the properties of the individual transistors Q1, Q2, Q3 and Q4 deviate from the ideal properties due to manufacturing variations, second order nonlinear distortion may occur during the conversion of the RF input signal into the baseband signal. This leads to a dynamic DC offset in the mixer output, as shown in FIG. 6. As is well known, the dynamic DC offset is proportional to the square of the input signal strength. Accordingly, the dynamic DC offset in the mixer output is increased as the level of the interfering wave included in the input signal becomes higher.

The dynamic DC offset compensator 40 shown in FIG. 7 includes a detector 2 that detects an RF input signal and outputs a detection signal and a controller 4 that adjusts the magnitude of the detection signal and generates a compensation signal. By this operation of the dynamic DC offset compensator 40, the compensation signal that the controller 4 outputs changes in accordance with the strength of the RF signal input to the mixer, thereby canceling the dynamic DC offset in the mixer output. The second order nonlinear distortion of the mixer 1 is caused by manufacturing variations and differs in characteristics individually. Thus, the dynamic DC offset compensator 40 further includes an adjustment signal input terminal 49 that receives an adjustment signal 5 for determining the magnitude of the compensation signal generated by the controller 4.

In U.S. Pat. No. 6,535,725, the method of determining the adjustment signal 5 shown in FIG. 7 is not described specifically. Thus, the inventor of the present invention made a study on a system configuration as shown in FIG. 8 as a system for determining the adjustment signal 5. In this system, a dynamic DC offset compensator including a detector 2, an input adjustment portion 3, and a controller 4 are connected to a mixer 1, as in the system shown in FIG. 7. In order to supply a dynamic DC offset adjustment signal 5 to the controller 4, a circuit including a comparator 9, a changeover switch 17, a static DC offset compensator 13, and an adjustment signal generator 16 are provided. The static DC offset compensator 13 includes a DAC (D/A converter) 11 and a register 12. The adjustment signal generator 16 includes a DAC 14 and a register 15. Reference numeral 6 denotes RF input lines, and reference numeral 7 denotes mixer output lines. Reference numeral 8 denotes a dynamic DC offset compensation signal, and reference numeral 10 denotes static DC offset compensation signals. A detection output from the detector 2, i.e., the level of the RF input signal, is represented by (I0+Idet), and a current supplied by the input adjustment portion 3 is represented by I1. The current I1 is a direct current that is set so as to make an input to the controller 4 zero when there is no input of the RF input signal and is deducted from an output from the detector 2.

As an internal circuit for the detector 2, the inventor of the present invention made a study on the configuration as shown in FIG. 9. An RF input signal supplied from the RF input lines 6 is detected by the detector including transistors 50, 51, 52, and 53 and then is output as a detector output current 54. FIG. 10 shows the relationship between the RF input level and the detector output current 54. The detector output current 54 when there is no input of the RF input signal is represented by I0. In-phase components generated in the collector currents of the transistors 50 and 51 increases in accordance with the increase of the RF input level, and the detector output current 54, which is the sum of those collector currents, increases as indicated by Idet, which is an increment resulting from the interfering wave input.

The comparator 9 shown in FIG. 8 is provided to discriminate the polarity of the DC offset that occurs in the mixer output when an interfering wave is input. First, when there is no input of the RF input signal, the changeover switch 17 is set so as to connect the comparator 9 to the static DC offset compensator 13. An output from the comparator 9 thus is accumulated in the register 12, and the compensation signals 10 for making the static DC offset zero are generated by the DAC 11 (this is static DC offset calibration). After the static DC offset in the mixer output has been made zero in the above-described manner, an interfering wave is input to cause a dynamic DC offset. In this state, the switch 17 is switched over so as to connect the comparator 9 to the adjustment signal generator 16. As in the case of the static DC offset calibration, an output from the comparator 9 is accumulated in the register 15, and the adjustment signal 5 is generated by the DAC 14 and is supplied to the controller 4. The compensation signal 8 generated by the controller 4 based on this adjustment signal 5 is supplied to the mixer 1, whereby the dynamic DC offset is adjusted so as to be zero.

As described above, a series of DC offset calibration processes is completed by first inputting the output from the comparator 9 to the static DC offset compensator 13 side to perform the static DC offset calibration and then to the adjustment signal generator 16 side to perform the dynamic DC offset calibration.

The correlation coefficient a is defined as the correlation coefficient between an amount of DC offset change in the mixer output that the compensation signal 8 causes by acting on the mixer 1 and an input to the detector 2. The correlation coefficient a is adjusted so that Y=α·(I0+Idet−I1) is satisfied, where Y denotes the magnitude of a dynamic DC offset caused by the mixer 1 when an interfering wave is input. When the circuit constants are set so that I1 is equal to I0, then α·(I0+Idet−I1) is α·Idet. When the interfering wave is switched off after the adjustment, the magnitude of the dynamic DC offset caused by the mixer 1 becomes zero and the increment Idet of the detector output current 54 resulting from the interfering wave input also becomes zero, so that the DC offset in the mixer output is maintained at zero.

The change in DC offset with time in each of the blocks shown in FIG. 8 during the above-described processes will be described specifically with reference to FIG. 11. In FIG. 11, (a) shows a DC offset in the mixer output (the magnitude thereof is represented by “a”), (b) shows a DC offset caused by the mixer 1 (the magnitude thereof is represented by “b”), (c) shows a dynamic DC offset compensation amount (the magnitude thereof is represented by “c”), (d) shows a static DC offset compensation amount (the magnitude thereof is represented by “d”), and (e) shows the ON/OFF state of the interfering wave. Since the DC offset in the mixer output corresponds to the sum of the DC offset b caused by the mixer itself, the dynamic DC offset compensation amount c, and the static DC offset compensation amount d, the relationship a=b+c+d is satisfied. In the initial state where the compensation is not yet performed, the mixer causes the static DC offset with the magnitude of X.

When the static DC offset calibration is performed at the time t1, the compensation amount d becomes −X, so that the DC offset in the mixer output temporarily is made zero. Thereafter, when the interfering wave is switched on at the time t2, a dynamic DC offset with the magnitude of −Y is generated in the mixer output due to the second order nonlinear distortion of the mixer. Then, at the time t3, the dynamic DC offset calibration is performed, so that the dynamic DC offset compensation amount c=Y is generated to make the DC offset in the mixer output zero. Finally, when the interfering wave is switched off at the time t4, the dynamic DC offset compensation amount c becomes zero. The DC offset X caused by the mixer and the static DC offset compensation amount d=−X are added together, so that the DC offset in the mixer output is made zero. That is, in this state, no dynamic DC offset is generated if the interfering wave is switched on/off.

However, for example, if I0 is greater than I1 (I0>I1) due to manufacturing variations, the state as shown in FIG. 12 will occur. Similarly to FIG. 11, FIG. 12 shows the change in DC offset with time in each of the blocks shown in FIG. 8. In FIG. 12, the processes until the time t3 are the same as those shown in FIG. 11. At the time t4, the dynamic DC offset compensation amount c does not become zero, but the compensation amount c corresponding to a (I0−I1) still remains. Thus, the DC offset in the mixer output does not become zero. That is, in this state, the dynamic DC offset with the magnitude of Z is generated by switching on/off the interfering wave, where Z=α·(I0−I1).

### SUMMARY OF THE INVENTION

Therefore, with the foregoing in mind, it is an object of the present invention to reduce an adjustment error of a dynamic DC offset with the magnitude of Z caused by manufacturing variations as described above.

In order to achieve the above object, a DC offset calibration system according to a first configuration of the present invention includes: a mixer that performs frequency conversion of an RF input signal by mixing the RF input signal with a local signal whose frequency is equal to a carrier frequency; a level detector that detects a level of the RF input signal; a controller that generates a dynamic DC offset compensation signal for compensating for a dynamic DC offset included in an output signal of the mixer, the dynamic DC offset compensation signal being generated based on an output from the level detector; a comparator that discriminates a polarity of the DC offset in the output signal of the mixer; a static DC offset compensator that generates a static DC offset compensation signal for making a DC offset that is included in the output signal of the mixer when there is no input of the RF input signal zero; and an adjustment signal generator that generates an adjustment signal for determining a magnitude of the dynamic DC offset compensation signal generated by the controller. When determining the magnitude of the adjustment signal, the DC offset calibration system is controlled so that DC offset calibration that determines a magnitude of the static DC offset compensation signal when there is no input of the RF input signal based on an output from the comparator and DC offset calibration that determines the magnitude of the adjustment signal when an interfering wave is input based on the output from the comparator are repeated alternately a plurality of times.

A DC offset calibration system according to a second configuration of the present invention includes: a mixer that performs frequency conversion of an RF input signal by mixing the RF input signal with a local signal whose frequency is equal to a carrier frequency; a level detector that detects a level of the RF input signal; a controller that generates a dynamic DC offset compensation signal for compensating for a dynamic DC offset included in an output signal of the mixer, the dynamic DC offset compensation signal being generated based on an output from the level detector; a comparator that discriminates a polarity of the DC offset in the output signal of the mixer; a static DC offset compensator that generates a static DC offset compensation signal for making a DC offset that is included in the output signal of the mixer when there is no input of the RF input signal zero; an adjustment signal generator that generates an adjustment signal for determining a magnitude of the dynamic DC offset compensation signal generated by the controller; and an input adjustment feedback loop that makes an input to the controller zero when there is no input of the RF input signal. When determining the magnitude of the adjustment signal, the DC offset calibration system is controlled so that a magnitude of the static DC offset compensation signal when there is no input of the RF input signal is determined based on an output from the comparator, then the input to the controller when there is no input of the RF input signal is adjusted so as to be zero by an operation of the input adjustment feedback loop, and finally the magnitude of the adjustment signal when an interfering wave is input is determined based on the output from the comparator.

With the above-described configurations, it is possible to reduce an adjustment error of a dynamic DC offset with the magnitude of Z caused by manufacturing variations. Therefore, in a radio receiver employing a direct conversion system, it becomes possible to compensate for a dynamic DC offset generated in a mixer output signal when an interfering wave is input with high accuracy.

### BRIEF DESCRIPTION OF THE DRAWINGS

FIG. 1 is a block diagram showing the configuration of a DC offset calibration system according to a first embodiment.

FIG. 2 is a waveform diagram showing the change in DC offset with time in respective portions of the DC offset calibration system according to the first embodiment.

FIG. 3 is a block diagram showing the configuration of a DC offset calibration system according to a second embodiment.

FIG. 4 is a waveform diagram showing the change in DC offset with time in respective portions of the DC offset calibration system according to the second embodiment.

FIG. 5 shows the spectrum of a signal that is input to a mixer in a radio receiver.

FIG. 6 shows the spectrum of a signal that is output from the same mixer when dynamic DC offset compensation is not performed.

FIG. 7 is a circuit diagram showing an exemplary configuration of main components of a conventional DC offset calibration system.

FIG. 8 is a block diagram showing an exemplary configuration of a proposed DC offset calibration system.

FIG. 9 is a circuit diagram of a detector included in the DC offset calibration system.

FIG. 10 is a graph showing the change in output current of the detector versus RF input level.

FIG. 11 is a waveform diagram showing the change in DC offset with time in respective portions of an example of the DC offset calibration system.

FIG. 12 is a waveform diagram showing the change in DC offset with time in respective portions of another example of the DC offset calibration system.

### DETAILED DESCRIPTION OF THE INVENTION

The DC offset calibration system according to the second configuration may be configured so that the input adjustment feedback loop includes an input adjustment portion that adds a DC level to the input to the controller and an input adjustment level compensating portion that compensates for the DC level supplied by the input adjustment portion based on the output from the comparator so as to make the input to the controller zero when there is no input of the RF input signal. When adjusting the input to the controller to be zero when there is no input of the RF input signal, the compensation by the input adjustment level compensating portion is performed, with a temporary adjustment signal having a predetermined magnitude being supplied to the controller instead of the adjustment signal.

The controller may be configured so that an output current from the level detector is supplied to an input stage of a current mirror circuit and an output current from the current mirror circuit is varied by changing a mirror ratio thereof, thereby generating the dynamic DC offset compensation signal for compensating for the dynamic DC offset included in the output signal of the mixer.

Hereinafter, the present invention will be described by way of illustrative embodiments with reference to the drawings.

### First Embodiment

Hereinafter, a DC offset calibration system according to a first embodiment of the present invention will be described with reference to the drawings.

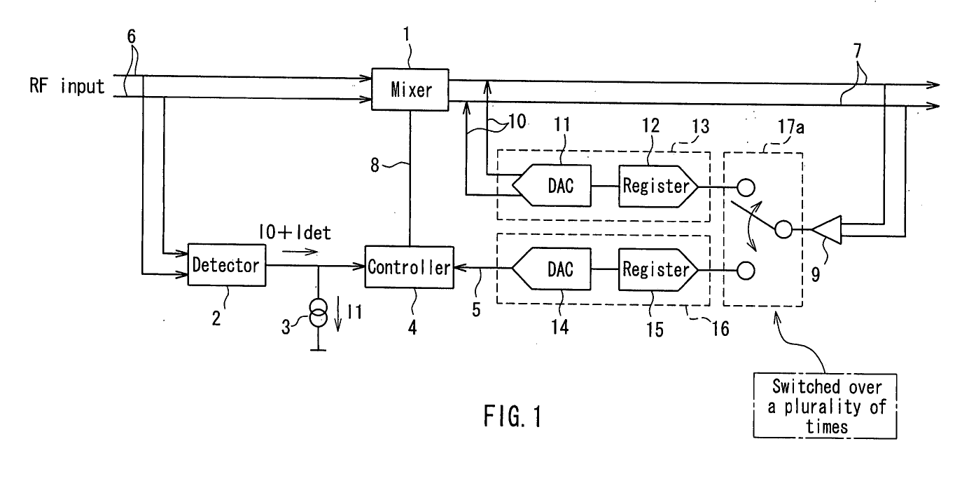

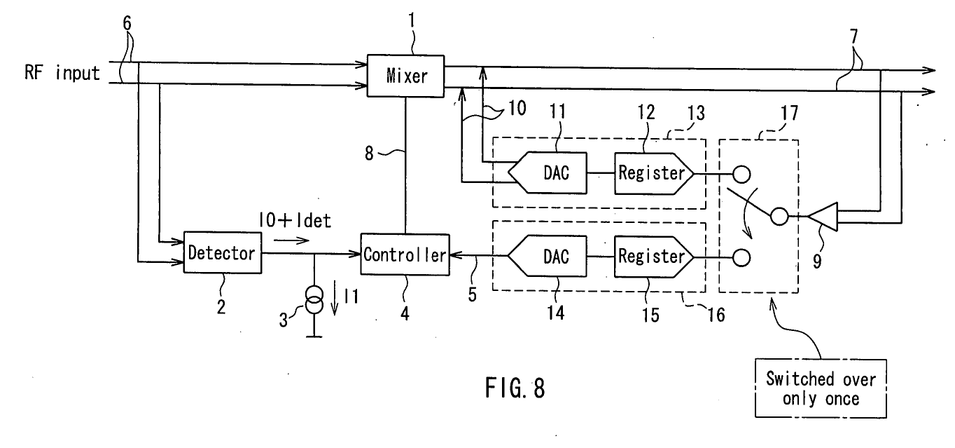

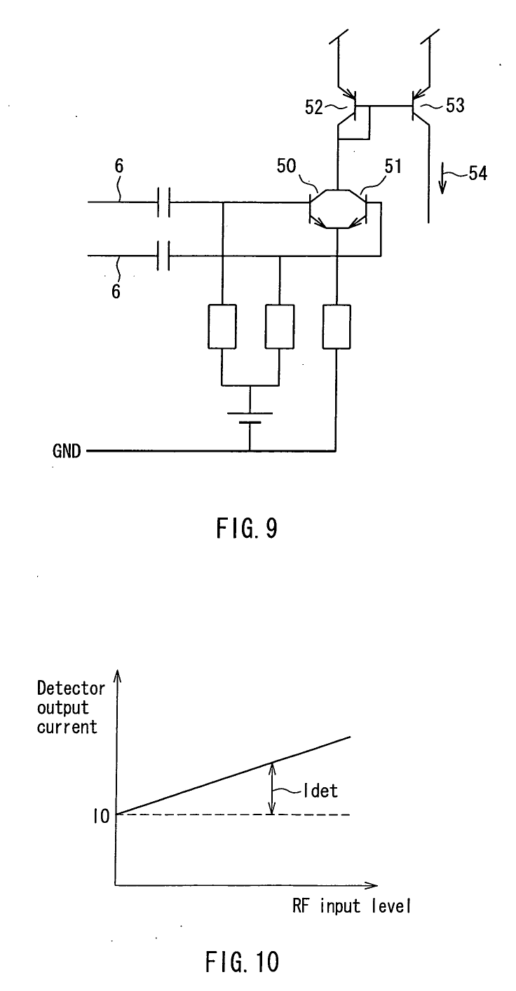

FIG. 1 is a block diagram showing the configuration of the calibration system according to the present embodiment. The basic configuration of this system is the same as that of the system shown in FIG. 8. In FIG. 1, the same elements as those in FIG. 8 are given the same reference numerals, and some of the descriptions thereof will be simplified.

A dynamic DC offset compensator including a detector 2, an input adjustment portion 3, and a controller 4 is connected to a mixer 1. In order to supply a dynamic DC offset adjustment signal 5 to the controller 4, a circuit including a comparator 9, a changeover switch 17a, a static DC offset compensator 13, and an adjustment signal generator 16 is provided. The static DC offset compensator 13 includes a DAC 11 and a register 12, and the adjustment signal generator 16 includes a DAC 14 and a register 15. A control portion of this system in not shown in FIG. 1, because the operation of this system is controlled merely by switching over the changeover switch 17a with a predetermined timing.

The detector 2 detects the level of an RF input signal that is input from RF input lines 6 and outputs a detection signal represented by I0+Idet. A signal obtained by deducting a current I1 supplied by the input adjustment portion 3 from the detection signal is input to the controller 4, where the magnitude of the signal is adjusted so as to convert the signal to a compensation signal 8. The compensation signal 8 then is input to the mixer 1. Due to the second order nonlinear distortion of the mixer 1, an interfering wave included in the RF input signal causes a dynamic DC offset to be generated in the mixer output signal output from mixer output lines 7. However, the compensation signal 8 acts on the mixer 1 so as to decrease the dynamic DC offset included in the mixer output signal. The controller 4 may be configured so that, for example, an output current from the detector 2 is supplied to an input stage of a current mirror circuit and an output current from the current mirror circuit is varied by changing a mirror ratio thereof, thereby generating the compensation signal 8 for compensating for a dynamic DC offset included in an output signal of the mixer 1.

The basic configuration of the calibration system according to the present embodiment is the same as that of the system shown in FIG. 8. However, the calibration system according to the present embodiment is different from the system shown in FIG. 8 in a series of DC offset calibration processes. In the system shown in FIG. 8, for example, a series of DC offset calibration processes is completed by first inputting the output from the comparator 9 to the static DC offset compensator 13 side to perform the static DC offset calibration and then to the adjustment signal generator 16 side to perform the dynamic DC offset calibration. In contrast, in the calibration system according to the present embodiment, a series of DC offset calibration processes is completed in a manner different from the conventional example. More specifically, in the calibration system according to the present embodiment, the static DC offset calibration is performed and then the dynamic DC offset calibration is performed by switching over the changeover switch 17a. With the adjustment signal being maintained, an operation of switching over the changeover switch 17a further is carried out to repeat the static DC offset calibration and the dynamic DC offset calibration again. After repeating this operation a predetermined number of times, the switch 17a is brought to a neutral position to complete the series of DC offset calibration processes.

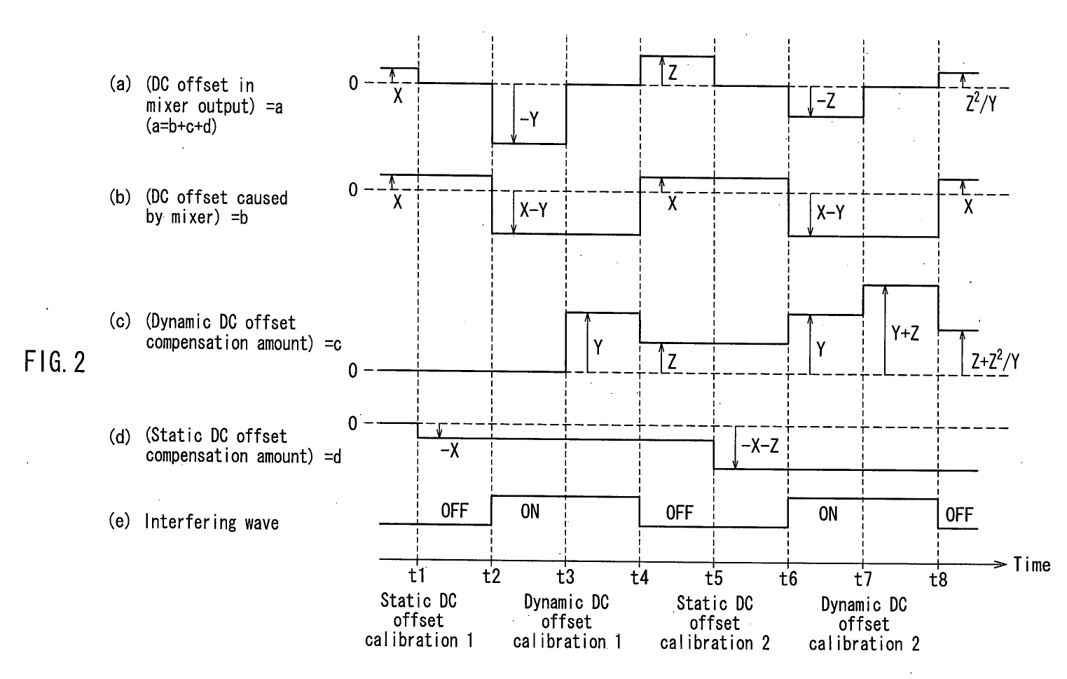

The operation of repeating the static DC offset calibration and the dynamic DC offset calibration a plurality of times as described above and an advantageous effect brought about by this operation will be described in detail with reference to FIG. 2.

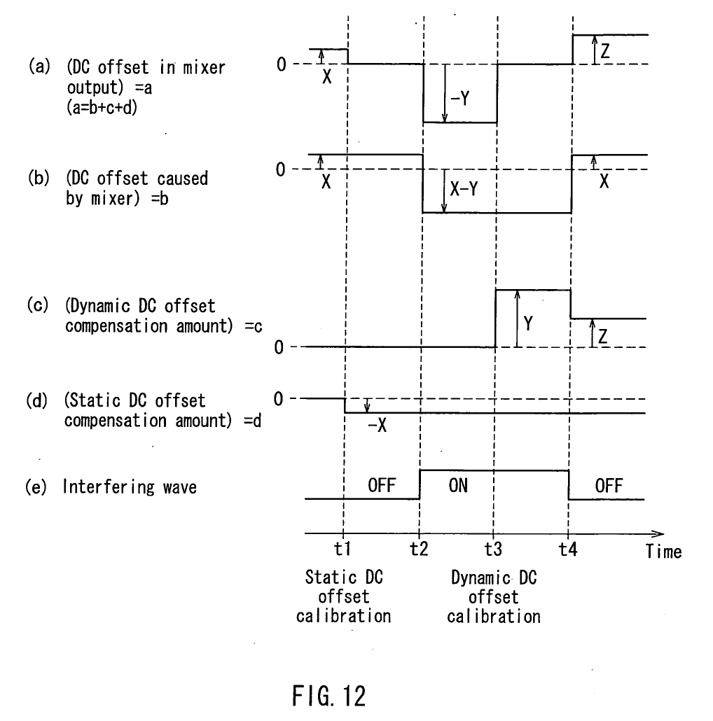

The type of the signal and the processes until the time t4 in FIG. 2 are identical to those described with reference to FIG. 12 above. At this time, an adjustment error with the magnitude of Z still remains. Second-time static DC offset calibration is performed at the time t5 with the value of the correlation coefficient α=Z/(I0−I1) being maintained. By this Second-time static DC offset calibration, the static DC offset compensation amount d becomes (−X−Z), so that the DC offset a in the mixer output is made zero. Then, when the interfering wave is switched on again at the time t6, the dynamic DC offset caused by the mixer itself due to the second order nonlinear distortion becomes −Y. The dynamic DC offset and the static DC offset are added together, so that the DC offset b caused by the mixer becomes (X−Y). The dynamic DC offset compensation amount c becomes Y, which is identical to that obtained at the time t3. As a result, the DC offset a in the mixer output is as follows: a=b+c+d=(X−Y)+Y+(−X−Z)=−Z.

Then, at the time t7, the correlation coefficient α is changed to (Y+Z)/(I0+Idet−I1) in order to cancel −Z. As a result, the dynamic DC offset compensation amount c becomes Y+Z. Finally, when the interfering wave is switched off at the time t8, an input to the controller 4 is (I0−I1)/(I0+Idet−I1)=Z/Y. Accordingly, the dynamic DC offset compensation amount c becomes (Y+Z)·Z/Y=Z+Z²/Y. Thus, the DC offset a in the mixer output becomes b+c+d=X+(Z+Z²/Y)+(−X−Z)=Z²/Y. That is, in this state, the dynamic DC offset with the magnitude of Z²/Y is generated by switching on/off the interfering wave.

The above-described processes can be summarized as follows. The magnitude of the dynamic DC offset, which is Y before the adjustment, becomes Z after the first-time adjustment and then becomes Z²/Y after the second-time adjustment. Similarly, after the nth-time adjustment, the magnitude of the dynamic DC offset becomes Y·(Z/Y)ⁿ. Since Z/Y is (I0−I1)/(I0+Idet−I1)<1, the adjustment error becomes closer and closer to zero as the number of times the adjustment is performed increases.

By the above-described operation, it becomes possible to reduce an adjustment error of the dynamic DC offset with the magnitude of Z caused by manufacturing variations.

### Second Embodiment

Next, a DC offset calibration system according the second embodiment of the present invention will be described with reference to the drawings.

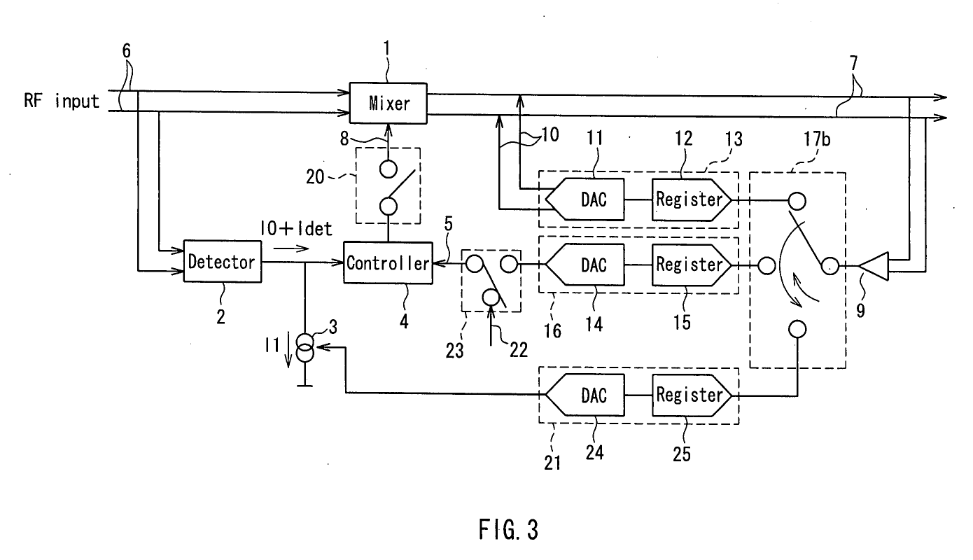

FIG. 3 is a block diagram showing the configuration of a calibration system according to the present embodiment. In this system, the same elements as those of the system shown in FIG. 8 are given the same reference numerals and the descriptions thereof will not be repeated.

The configuration of this calibration system is different from that of the system shown in FIG. 8 in that: a switch 20 for turning on/off a dynamic DC offset compensation signal is provided between a controller 4 and a mixer 1; a detector-output-adjustment-current compensator 21 for compensating for a direct current I1 is provided; and a switch 23 for the connection of an adjustment signal test input line 22 is provided. The detector-output-adjustment-current compensator 21 includes a DAC 24 and a register 25. Furthermore, by switching over a changeover switch 17b, an output from the comparator 9 is supplied not only to a static DC offset compensator 13 and an adjustment signal generator 16 but also to the detector-output-adjustment-current compensator 21.

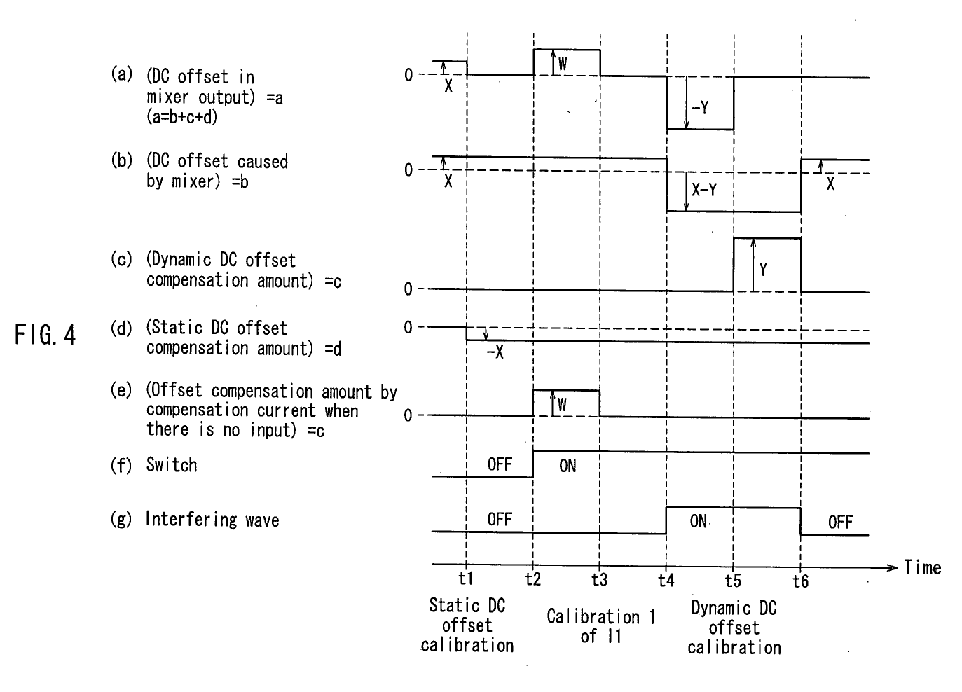

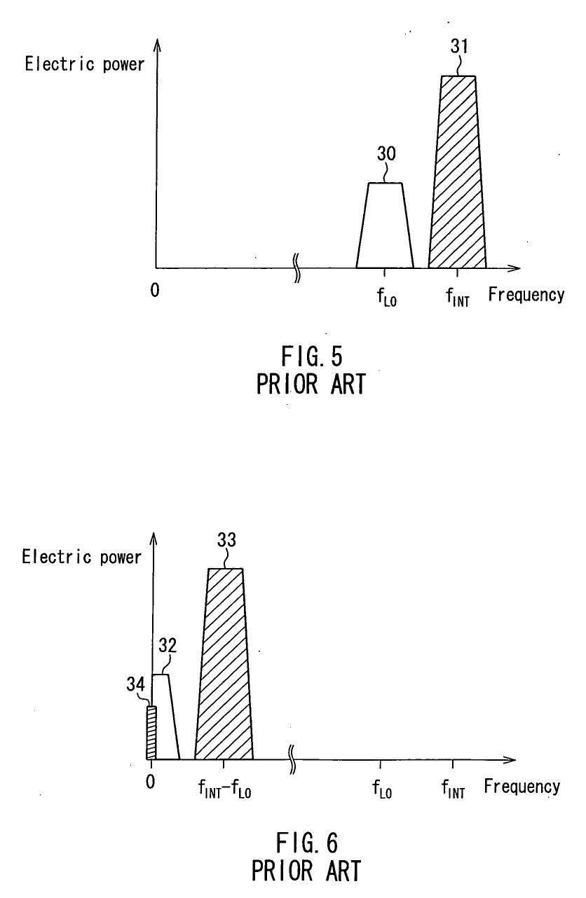

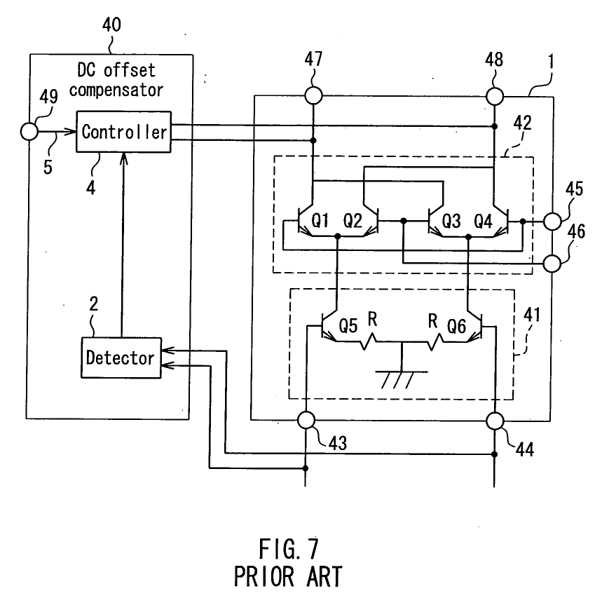

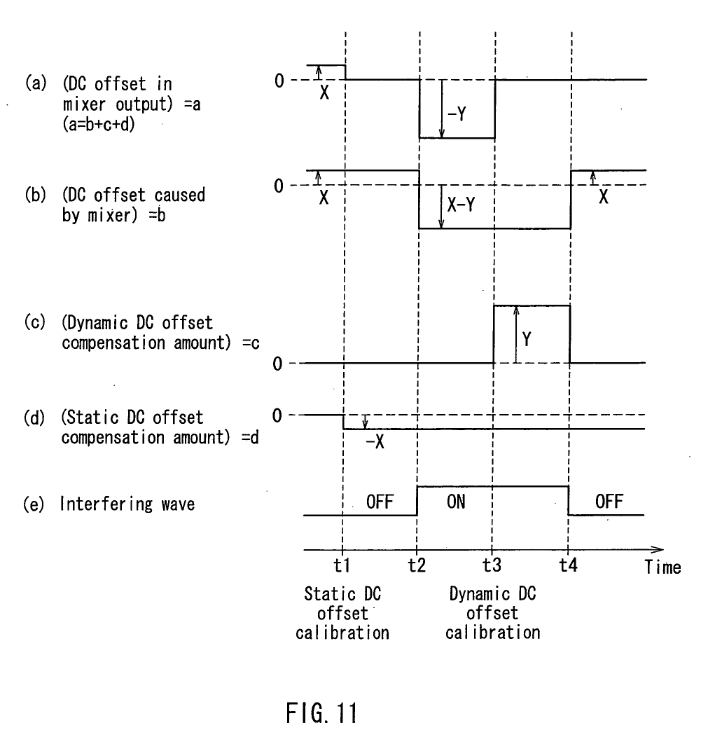

The operation of this system will be described with reference to FIG. 4. In FIG. 4, (a) to (d) show the same as those in FIG. 11. First, in the state where there is no RF input signal, the switch 20 is turned off, and an output from the comparator 9 is input to the static DC offset compensator 13 side at the time t1. Then, the compensation amount d becomes −X, so that the static DC offset in the output from the mixer 1 becomes zero.

Then, at the time t2, the changeover switch 17b is switched over so that the output from the comparator 9 is input to the detector-output-adjustment-current compensator 21 side. At the same time, the switch 20 is turned on as shown in FIG. 4(f). Since there is no input of the RF input signal, the output form the detector 2 is I0, and thus (I0−I1) is input to the controller 4. At this time, an adjustment signal for controlling the controller 4 is input from the adjustment signal test input line 22, so that a is set to be a constant value other than zero (this constant value is represented by α0), where α is the correlation coefficient between a compensation amount for the DC offset in the mixer output and an input to the controller 4. This causes an offset to be generated by the compensation current when there is no input of the RF input signal (FIG. 4(e)), so that the difference between I0 and I1 appears in the mixer output as a DC offset with the magnitude of α0·(I0−I1) (which is represented by W) (FIG. 4(a)). This DC offset W is detected by the comparator 9. Due to the compensation for the direct current I1 performed at the time t3, a feedback is made so as to cause the detector-output-adjustment-current compensator 21 to adjust I1 to be equal to I0. That is, an input adjustment feedback loop is constituted that adjusts an input to the controller 4 to be zero when there is no input of the RF input signal based on the compensation for the output from the input adjustment portion 3 by the detector-output-adjustment-current compensator 21.

After I1 has been made equal to I0, an adjustment current 5 is turned to an output from the DAC 14 by the switch 23 at the time t4, and an output from the comparator 9 is input to the dynamic DC offset adjustment signal generator 16 side by the changeover switch 17b. Then, an interfering wave is input through the RF input, and dynamic DC offset calibration is performed at the time t5. By this dynamic DC offset calibration, the DC offset in the mixer output becomes identical to the response shown in FIG. 11, and thus, no dynamic DC offset is generated if the interfering wave is switched on/off after the adjustment. After the dynamic DC offset calibration at the time t5, no DC offset appears in the mixer output even if the interfering wave is switched off at the time t6.

By the above-describes operation, it is possible to make I1 equal to I0 regardless of the manufacturing variations, thus allowing an adjustment error of the dynamic DC offset with the magnitude of Z=α·(I0−I1) to be made zero.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. ADC offset calibration system comprising:
a mixer that performs frequency conversion of an RF input signal by mixing the RF input signal with a local signal whose frequency is equal to a carrier frequency;
a level detector that detects a level of the RF input signal;
a controller that generates a dynamic DC offset compensation signal for compensating for a dynamic DC offset included in an output signal of the mixer, the dynamic DC offset compensation signal being generated based on an output from the level detector;
a comparator that discriminates a polarity of the DC offset in the output signal of the mixer;
a static DC offset compensator that generates a static DC offset compensation signal for making a DC offset that is included in the output signal of the mixer when there is no input of the RF input signal zero; and
an adjustment signal generator that generates an adjustment signal for determining a magnitude of the dynamic DC offset compensation signal generated by the controller,
wherein, when determining the magnitude of the adjustment signal, the DC offset calibration system is controlled so that DC offset calibration that determines a magnitude of the static DC offset compensation signal when there is no input of the RF input signal based on an output from the comparator and DC offset calibration that determines the magnitude of the adjustment signal when an interfering wave is input based on the output from the comparator are repeated alternately a plurality of times.

2. A DC offset calibration system comprising:
a mixer that performs frequency conversion of an RF input signal by mixing the RF input signal with a local signal whose frequency is equal to a carrier frequency;
a level detector that detects a level of the RF input signal;
a controller that generates a dynamic DC offset compensation signal for compensating for a dynamic DC offset included in an output signal of the mixer, the dynamic DC offset compensation signal being generated based on an output from the level detector;
a comparator that discriminates a polarity of the DC offset in the output signal of the mixer;
a static DC offset compensator that generates a static DC offset compensation signal for making a DC offset that is included in the output signal of the mixer when there is no input of the RF input signal zero;
an adjustment signal generator that generates an adjustment signal for determining a magnitude of the dynamic DC offset compensation signal generated by the controller; and
an input adjustment feedback loop that makes an input to the controller zero when there is no input of the RF input signal,
wherein, when determining the magnitude of the adjustment signal, the DC offset calibration system is controlled so that a magnitude of the static DC offset compensation signal when there is no input of the RF input signal is determined based on an output from the comparator, then the input to the controller when there is no input of the RF input signal is adjusted so as to be zero by an operation of the input adjustment feedback loop, and finally the magnitude of the adjustment signal when an interfering wave is input is determined based on the output from the comparator.

3. The DC offset calibration system according to claim 2, wherein the input adjustment feedback loop includes an input adjustment portion that adds a DC level to the input to the controller and a detector-output-adjustment-current compensator that compensates for the DC level supplied by the input adjustment portion based on the output from the comparator so as to make the input to the controller zero when there is no input of the RF input signal,
wherein, when adjusting the input to the controller to be zero when there is no input of the RF input signal, the compensation by the input adjustment level compensating portion is performed, with a temporary adjustment signal having a predetermined magnitude being supplied to the controller instead of the adjustment signal.

4. The DC offset calibration system according to claim 1, wherein the controller is configured so that an output current from the level detector is supplied to an input stage of a current mirror circuit and an output current from the current mirror circuit is varied by changing a mirror ratio thereof, thereby generating the dynamic DC offset compensation signal for compensating for the dynamic DC offset included in the output signal of the mixer.

5. The DC offset calibration system according to claim 2, wherein the controller is configured so that an output current from the level detector is supplied to an input stage of a current mirror circuit and an output current from the current mirror circuit is varied by changing a mirror ratio thereof, thereby generating the dynamic DC offset compensation signal for compensating for the dynamic DC offset included in the output signal of the mixer.
